(19) United States
(12) Patent Application Publication
(10) Pub. No.: US 2008/0181167 A1
(43) Pub. Date: Jul. 31, 2008

(54) INTERLEAVED FRAME STRUCTURE ENABLING RELAY AND ACCESS LINKS TO SHARE A CHANNEL FOR MULTI-HOP WIRELESS BROADBAND ACCESS COMMUNICATIONS

(76) Inventors: Jaroslaw J. Sydir, San Jose, CA (US); Wendy C. Wong, San Jose, CA (US); Kerstin Johnsson, Palo Alto, CA (US); Hyunjeong Hannah Lee, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/923,600

(22) Filed: Oct. 24, 2007

Related U.S. Application Data
(60) Provisional application No. 60/854,470, filed on Oct. 25, 2006.

(51) Int. Cl. H04B 7/14

(52) U.S. Cl. 370/315

(57) ABSTRACT

An interleaved frame structure provides the ability for access links and relay links to share a single channel and enable the transmission of packet information across a 2-hop path within one frame. The interleaved frame structure in combination with fast processing at the Relay Station (RS) allows scheduled packet information to travel from a Mobile Subscriber (MS) to its MR enabled base station (MR-BS) within one frame.

The present application claims priority to U.S. patent application Ser. No. 60/854,470, filed Oct. 25, 2006, entitled “Interleaved Frame Structure Enabling Relay and Access Links to Share a Channel for Multi-Hop Wireless Broadband Access Communications,” the entire disclosure of which is hereby incorporated by reference in its entirety.

Developments in a number of different digital technologies have greatly increased the need to transfer data from one device across a network to another system. Technological developments permit digitization and compression of large amounts of voice, video, imaging, and data information, which may be transmitted from laptops and other digital equipment to other devices within the network. These developments in digital technology have stimulated a need to deliver and supply data to these processing units.

It is becoming increasingly attractive to use wireless nodes in a wireless network as relaying points to extend range and/or reduce costs of a wireless network. A Multi-hop Relay (MR) network may use fixed and/or mobile stations as relaying points to optimize communications and increase the efficiency of transmissions. One notable issue is how to coordinate the selection of optimal transmission paths using new protocols and architectures and reduce costs associated with these networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram illustrating an arrangement of wireless nodes in an example wireless network for conveying multi-hop link information according to one embodiment of the present invention;

FIG. 2 is an example Multi-hop Relay (MR) network in which a MR-BS is at the root and RSs are at the leaves of the tree-like topology;

FIG. 3 is an example frame structure that allows relay links and access links to share a channel by interleaving the relay links with the access links in accordance with the present invention; and

FIG. 4 shows a 2-hop link within an MR deployment.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Wireless multi-hop relay systems have become the focus of several current standardization efforts. For example, for WLANs the Institute of Electrical and Electronics Engineers (IEEE) 802.11s Mesh Task Group (TG) is actively working on standard solutions for WLAN mesh networking. Additionally, the IEEE 802.16j Multi-hop Relay (MR) task group is also evaluating solutions for standardization in furtherance of the IEEE 802.16j project approval request for wireless broadband access (WBA) networks.

The multi-hop relay systems provide a cost effective way for multi-media traffic to increase in range. The relay stations offer extended coverage through existing networks and the MR system is a cost effective solution accommodating many mobile subscribers, establishing wide area coverage and providing higher data rates. Thus, the multi-hop relay systems enhance throughput and capacity for 802.16 systems and enable rapid deployment which reduces the cost of system operation.

MR relay stations are intended to be fully backward compatible in the sense that they should operate seamlessly with existing 802.16e subscriber stations. A further phase of 802.16 is expected to introduce enhanced relay and WBA subscriber stations designed for use in MR networks. While the embodiments discussed herein may refer to 802.16 wireless broadband access networks, sometimes referred to as WiMAX, an acronym that stands for Worldwide Interoperability for Microwave Access, which is a certification mark for products that pass conformity and interoperability tests for the IEEE 802.16 standards, they are not so limited and may be applicable to WLAN, other types of mesh networks or even combinations of different networks. Multi-hop relay techniques may be applied to other emerging standards such as 3rd Generation Partnership Project (3GPP) for the Long Term Evolution (LTE).

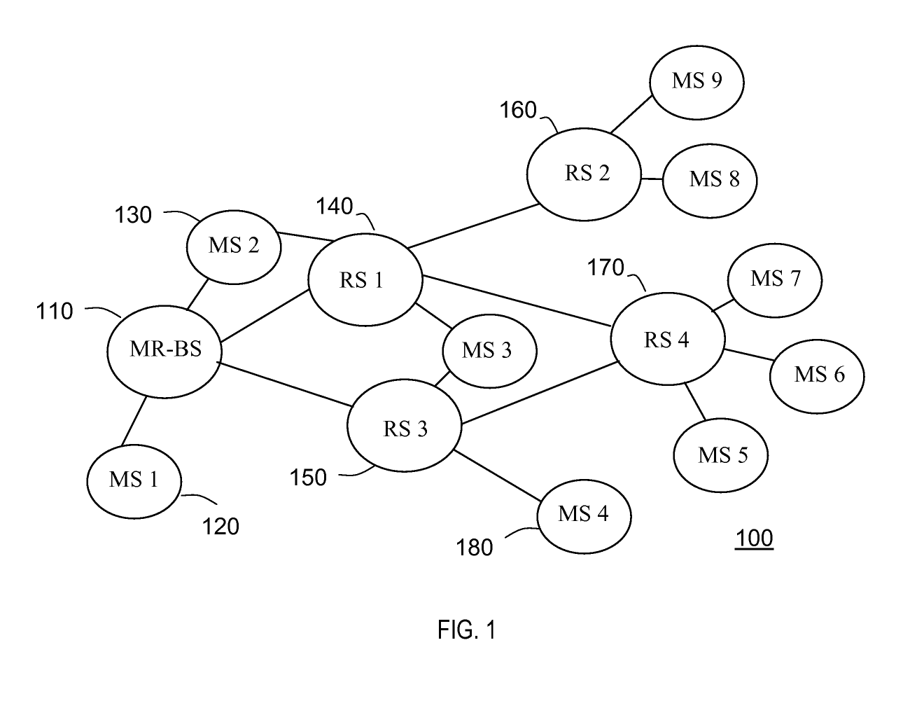

FIG. 1 is a diagram illustrating an arrangement of wireless nodes in an example wireless network for conveying multi-hop link information according to one embodiment of the present invention. A Multi-hop Relay (MR) network 100 may be any system having devices capable of transmitting and/or receiving information via at least some Over-The-Air (OTA) Radio Frequency (RF) links. For example in one embodiment, the topology of MR network 100 may include an MR Base Station (MR-BS) 110 that provides direct access to multiple Mobile Stations (MSs) 120 and 130. MR-Base Station 110 also connects to a plurality of unwired relay nodes shown as Relay Stations (RS) 140 and 150 in the figure.

Relay Stations (RSs) 140 and 150 wirelessly communicate and relay messages in MR network 100 using wireless protocols and/or techniques compatible with one or more of the various 802 wireless standards for WPANs and/or standards for WMANs, although the inventive embodiments are not limited in this respect. As illustrated in the figure, Relay Stations (RSs) 140 and 150 provide access to Mobile Stations 130 and 180 as well as relay data on behalf of other RSs. In certain non-limiting example implementations of the inventive embodiments, the topology illustrated is tree-like with the MR-BS at the root and MSs at the leaves to provide multiple communication paths or links. Access links provide the supported paths between the MR-BS and the MS and further between the RS and the MS. Relay links provide the support paths between the MR-BS and the RSs.

MR network 100 may be comprised of several macro cells, each of which may generally comprise at least one base station similar to MR base station 110 and a plurality of relay stations similar to RSs 140 and 150 dispersed throughout each macro cell and working in combination with the base station(s) to provide a full range of coverage to client stations. The multi-hop topology between MR-BS 110 and RSs 140 and 150 can be viewed as a Point-to-Multipoint (PMP) link. Further, RS 140 is connected to RS 160 and RS 170 via a PMP link, where each PMP link relies on the stations to maintain time and frequency synchronization that is performed via the broadcast and reception of a downlink (DL) preamble, whereas uplink (UL) synchronization is performed by a ranging process.

MR network 100 utilizes a frame structure which allows multiple relay links to share a channel, and thus, multiple PMP links may be supported on the same channel. When multiple PMP links share a channel, the stations that participate in the links synchronize and data is transmitted to minimize interference. The frame structure is configurable to optimize the topology and the requirements for deployment and allow the multiple PMP links to share the channel while utilizing a combination of time division multiplexing (TDM) and spatial reuse.

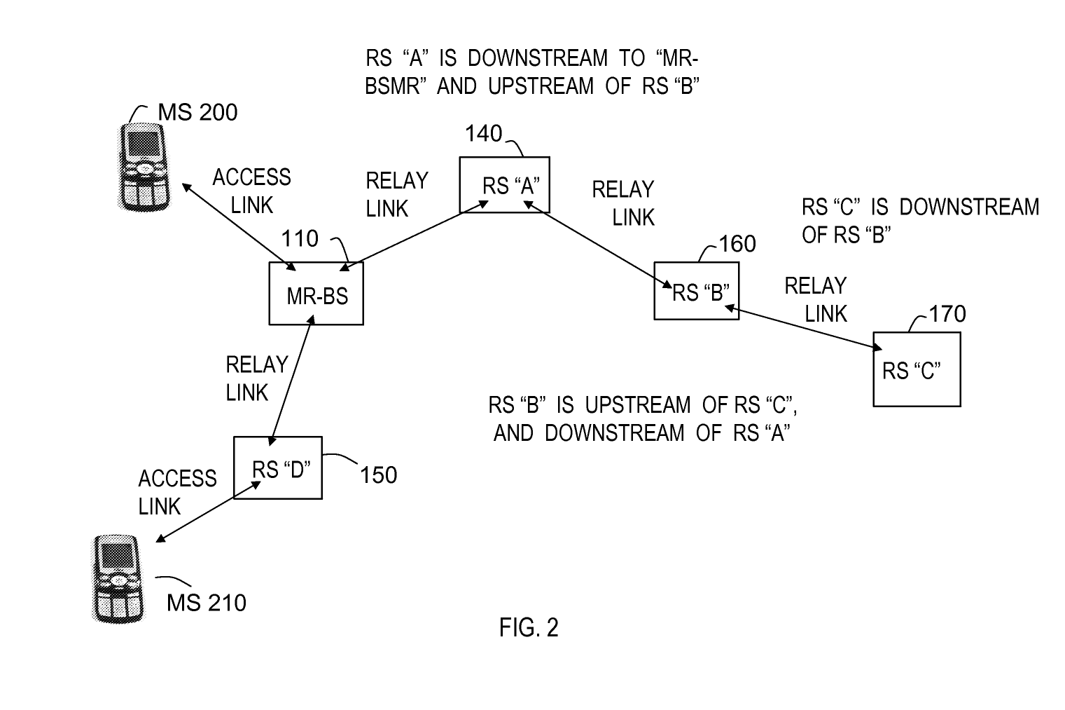

FIG. 2 is an example of a Multi-hop Relay (MR) network 100 in which MR-BS 110 is at the root and RS 140, RS 150, RS 160 and RS 170 are intermediate nodes in a tree-like topology. Access links support direct communication paths between a MR-BS and MSs such as, for example, the link between MR-BS 110 and mobile station 200 or between an RS and MSs such as, for example, the link between RS 150 and mobile station 210. Relay links support direct communication paths between a MR-BS and RSs such as, for example, the link between MR-BS 110 and Relay Station 140. In the example the figure illustrates that RS 140 is downstream from MR-BS 110 while RS 160 is downstream of RS 140, but upstream to RS 170.

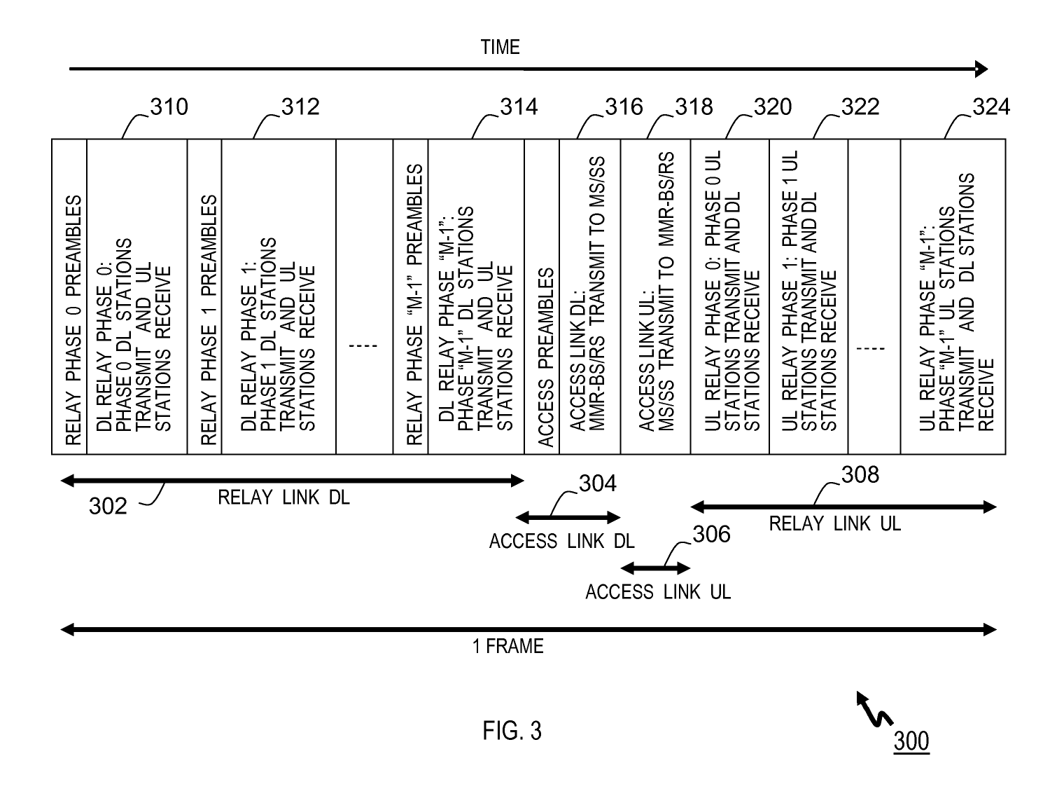

FIG. 3 is a frame structure 300 that allows relay links and access links to share a channel by interleaving the transmission of data on relay links with the transmission of data on access links. The figure shows one example embodiment of a TDD frame divided into portions that include RELAY LINK DL 302, ACCESS LINK DL 304, ACCESS LINK UL 306 and RELAY LINK UL 308, with the portions further divided into a number of phases. The internal structure of Relay Link DL 302 can be different from the structure of Access Link DL 304. Similarly, the internal structure of Relay Link UL 308 can be different from that of Access Link 306. Each DL phase in RELAY LINK DL 302 has a corresponding UL phase in RELAY LINK UL 308 such that the number of DL phases is the same as the number of UL phases. Specifically, the number of DL phases in RELAY LINK DL 302 represented by DL phases 310, 312, and . . . 314 matches the number of UL phases in RELAY LINK UL 308 represented by UL phases 320, 322, and . . . 324. Note that the first symbol in each DL phase is a preamble.

The number of RSs included in multi-hop network 100 may be dynamically changed as part of the frequency planning and deployment process. Frame structure 300 may be adjusted accordingly during operation of the system to include the appropriate phases for these stations. Frame structure 300 allows access and relay links to share a channel in TDM fashion by partitioning the access and relay links into separate groups, where each group is assigned to a phase. All RSs that are DL stations in a phase transmit their preamble in the DL portion of that phase. All preambles within a phase are transmitted in the same symbol, so assigning two RSs to be DL stations in a phase causes them to transmit their preambles at the same time.

The interleaved frame structure not only enables the sharing of a channel between relay and access links, but further provides the ability to transmit a packet across a 2-hop path within one frame if the processing at the RS is sufficient. An n-hop link exists if an MR-BS and an MS is separated by n-1 RSs, or alternatively, if an MR-BS and a SS is separated by n-1 RSs. In general, packets traversing multiple hops may experience increased packet delays which may reduce the Quality of Service (QoS) of the system. However, frame structure 300 enables relays to mitigate any increased packet delay which improves the QoS for a 2-hop link.

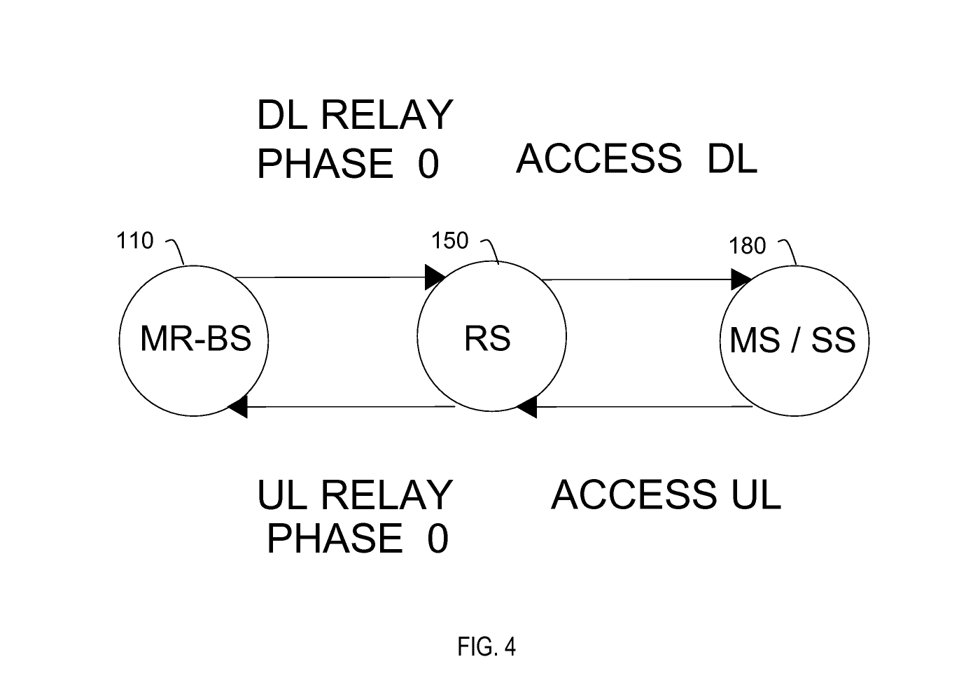

FIG. 4 shows a 2-hop link within an MR deployment such as, for example, in multi-hop network 100 illustrated in FIG. 1. By using the interleaved frame structure, packet information may travel from an MR-BS 110 to an MS 180 within one frame for the DL. During DL RELAY PHASE 0, information travels from MR-BS 110 to RS 150. RS 150 receives the information from MR-BS 110 and responds by sending the information to MS 180 during the ACCESS LINK DL of the same frame. Briefly referring now to FIG. 3, the interleaved frame structure provides a slot 310 for DL RELAY PHASE 0 that signifies packet information to be communicated from MR-BS 110 to RS 150. Again, RS 150 receives that packet information from MR-BS 110 and responds by sending the packet information to MS 180 in time slot 316 during the ACCESS LINK DL of the same frame.

In the UL subframe the interleaved frame structure provides time slots that schedule packet information travel from an MS to its MR-BS within one frame. During the ACCESS LINK UL (slot 318 shown in FIG. 3), the MS sends packet information to the RS. The RS receives that packet information from the MS and responds by sending the information to the MR-BS during the UL RELAY PHASE 0 (slot 320 shown in FIG. 3) of that same frame. Hence, assuming that fast processing of information exists at the RSs, interleaved frame structure 300 provides the ability to transmit a packet within a frame for a 2-hop link between the MR-BS and it's MS/SS which at least partially mitigates some delay in using relays.

By way of example, 90% of MR deployment contains 2-hop links only. In these deployment situations interleaved frame structure 300 would improve the QoS of approximately 90% of the users in the MR deployment. In general, interleaved frame structure 300 may avoid introducing an extra delay of 1 frame for an n-hop link based on the following satisfied conditions: the number of relay phases M>(n-1) for an n-hop link; stations are assigned to a correct phase; the processing at the RS is sufficient to turn around packet information to retransmit; and allocation is available that allows the RS to transmit what it receives from the uplink/downlink to the downlink/uplink. The correct RS product design and a 2-hop link may satisfy the conditions for taking advantage of interleaved frame structure 300.

By now it should be apparent that the interleaved frame structure provides the ability for the access and relay links to share a single channel and enable the transmission of packets across a 2-hop path within one frame. Specifically, the interleaved frame structure in combination with fast processing at the RS allows scheduled packet information to travel from an MS to its MR-BS within one frame.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method of communicating, comprising:
using an interleaved frame structure to provide access links and relay links to share a single channel and enable transmission of packets across a 2-hop path within one frame.

2. The method of claim 1, further comprising:
using the interleaved frame structure to interleave and access a relay frame structure whose internal structure is different.

3. The method of claim 1, further comprising:
using the interleaved frame structure to mitigate packet delays in a Multi-hop Relay (MR) network deployed in a limited channel bandwidth.

4. A mobile device that configures a frame structure to transmit with relay links and access links on a shared channel by interleaving the transmission of data on relay links with the transmission of data on access links.

5. The mobile device of claim 4 wherein the frame structure is a TDD frame divided into portions that include a relay down link, an access down link, an access up link, and a relay up link, with the portions further divided into a number of phases.

6. The mobile device of claim 4 wherein the frame structure conveys multi-hop link information for Worldwide Interoperability for Microwave Access (WiMAX).

7. The mobile device of claim 4 wherein a transmitter of the mobile device transmits a frame structure where an internal structure of the relay down link is different from a structure of the access down link.

8. The mobile device of claim 4 wherein the internal structure of the relay up link is different from the access up link.

9. The mobile device of claim 4 wherein a number of down link phases in the relay down link matches a number of up link phases in the relay up link in the transmitted frame structure.

10. The mobile device of claim 4 wherein a first symbol in each down link phase is a preamble.

11. The mobile device of claim 4 wherein the frame structure is adjusted by the mobile device during operation to include appropriate phases for the relay stations (RSs) in the multi-hop network.

12. A mobile device to operate in a multi-hop network and communicate by forming a frame structure where access links and relay links share a channel in time division multiplexing (TDM) by partitioning the access links and the relay links into separate groups, where each of the groups is assigned to a phase.

13. The mobile device of claim 12 wherein the access links support direct communication paths between a Multi-hop Relay Base Station (MR-BS) and the mobile device and relay links support direct communication paths between a MR-BS and Relay Stations (RSs).

14. The mobile device of claim 13 wherein the frame structure is dynamically changed by the mobile device during operation to include appropriate phases for the RSs in the multi-hop network.

15. The mobile device of claim 12 wherein a number of down link phases in a relay down link matches a number of up link phases in a relay up link in the frame structure.

16. A multi-hop operating system that includes devices that communicate using an interleaved frame structure having relay links and access links that share a channel by interleaving the transmission of data on relay links with the transmission of data on access links.

17. The multi-hop operating system of claim 16 wherein the interleaved frame structure is a TDD frame divided into portions that include a relay down link, an access down link, an access up link, and a relay up link, with the portions further divided into a number of phases.

18. The multi-hop operating system of claim 16 wherein the interleaved frame structure includes a number of down link phases in a relay down link that matches a number of up link phases in a relay up link.

19. The multi-hop operating system of claim 16 where Relay Stations (RSs) operate in the system as down link stations in a phase and transmit their preamble in a down link portion of the phase.

20. The multi-hop operating system of claim 16 where the interleaved frame structure provides a slot for a down link relay phase that signifies packet information communicated from a Multi-hop Relay Base Station (MR-BS) to a Relay Station (RS), where the RS responds by sending the packet information to a Mobile Station (MS) in a time slot during an access down link of a same frame.
